(19) United States
(12) Patent Application Publication
(10) Pub. No.: US 2026/0252923 A1
(43) Pub. Date: Aug. 27, 2026

(54) NETWORK OF ARTIFICIAL INTELLIGENCE (AI) SYSTEMS FOR CONDITIONAL, MODULAR, MULTI-STEP TASK PROCESSING

(71) Applicant: Atigro, Vienna, VA (US)

(72) Inventors: Ken Fischer, Tysons Corner, VA (US); Pranjal Biyani, Hooghly (IN); Kavita R. Tumpalli, Hyderabad (IN)

(21) Appl. No.: 19/358,213

(22) Filed: Oct. 14, 2025

Related U.S. Application Data
(60) Provisional application No. 63/760,031, filed on Feb. 18, 2025.

(51) Int. Cl. G06N 5/043

(52) U.S. Cl. CPC G06N 5/043

(57) ABSTRACT

An example operation may include one or more of receiving a request to perform an artificial intelligence (AI) task, dynamically configuring a network of AI nodes for processing the AI task, wherein the dynamically configuring comprises connecting an output of an AI node to an input of a different AI node, among the network of AI nodes, generating an input for the plurality of AI nodes which includes an identifier of the AI task and input data, inputting the input to an initial node among the network of AI nodes, executing the AI task based on the input and the network of AI nodes to generate an output from a last node in the network of nodes, and transferring the output to a device.

### CROSS REFERENCE

This application claims priority to U.S. provisional application no.: 63/760,031, filed on February 18, 2025, the entire disclosure of which is incorporated by reference herein.

### BACKGROUND

Artificial intelligence (AI) is a branch of computer science that relates to the simulation of intelligent behavior in computers. A device that includes AI functionality is able to mimic cognitive functions. For example, it may perceive its environment, take actions, learn from experiences and/or adjust to new inputs.

### SUMMARY

One example embodiment provides a method that includes at least one of receiving a request to perform an artificial intelligence (AI) task, dynamically configuring a network of AI nodes for processing the AI task, wherein the dynamically configuring comprises connecting an output of an AI node to an input of a different AI node, among the available network of AI nodes, generating an input for the network of AI nodes which includes an identifier of the AI task and input data, inputting the input to an initial node among the network of AI nodes, executing the AI task based on the input and the network of AI nodes to generate an output from a last node in the network of nodes, and transferring the output to a device.

Another example embodiment provides a system that includes a memory communicatively coupled to a processor, wherein the processor may perform at least one of receiving a request to perform an artificial intelligence (AI) task, dynamically configure a network of AI nodes for processing the AI task, wherein the dynamic configuration comprises a connection of an output of an AI node to an input of a different AI node, among the network of AI nodes, generate an input for the network of AI nodes which includes an identifier of the AI task and input data node among the network of AI nodes, execute the AI task based on the input and the network of AI nodes to generate an output from a last node in the network of nodes, and transfer the output to a device.

A further example embodiment provides a non-transitory computer readable storage medium comprising instructions, that when read by a processor, cause the processor to perform at least one of receiving a request to perform an artificial intelligence (AI) task, dynamically configuring a network of AI nodes for processing the AI task, wherein the dynamically configuring comprises connecting an output of an AI node to an input of a different AI node, among the network of AI nodes, generating an input for the network of AI nodes which includes an identifier of the AI task and input data, inputting the input to an initial node among the network of AI nodes, executing the AI task based on the input and the network of AI nodes to generate an output from a last node in the network of nodes, and transferring the output to a device.

### BRIEF DESCRIPTION OF THE DRAWINGS

FIG. 1 is a diagram illustrating a system for processing tasks using a network of AI nodes according to an embodiment of the instant solution.

FIG. 2A is a diagram illustrating an example of an AI node included in the network of AI nodes of FIG. 1, according to an embodiment of the instant solution.

FIG. 2B is a diagram depicting an AI processing node within an AI system as an embodiment of the instant solution.

FIG. 3 is a diagram illustrating a computing system for use in any of the example embodiments according to an embodiment of the instant solution.

FIG. 4 is a flow diagram illustrating a method according to examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

FIGS. 6A-6B are diagrams illustrating examples of network configurations of AI nodes according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a processing network of AI systems referred to herein as AI nodes (or AI cells). The system may dynamically set up an amount, an order, and roles, of AI nodes in a network for processing a task in a collaborative manner. The outputs from some AI nodes may be inputs to other AI nodes, etc. The arrangement of the AI nodes may be determined based on a task to be performed, roles of the AI models associated with the AI nodes, input data to be retrieved for input to a model, software systems involved in the task, and the like. Each AI node may include an AI model, an executable for executing the AI model, and the like. Each AI node may also include a pre-processing stage for transforming input data for the AI model, a post-processing stage for processing the output of the AI model, receiving input from a user, obtaining model feedback, and the like. In some embodiments, AI nodes may be grouped into subnetworks that share similar roles or data types, and connections between nodes and subnetworks may evolve dynamically over time, supporting re-linking, re-routing, fallback dependencies and cross-network invocation of processing pipelines. Each node integrates both deterministic functions and artificial intelligence processes within the same technical context. For example, the pre-processing and post-processing components of a node may execute deterministic functions such as data validation, transformation, or rule enforcement, while the AI processing component may invoke an artificial intelligence model to perform reasoning or inference. The combination of deterministic and AI processing within a single node ensures that structured operations and contextual reasoning are executed in a unified, modular architecture, rather than as disjointed tools or layers. The node editing component may accordingly alter deterministic logic, AI models, or both, depending on task requirements.

The system may be managed by a software application that dynamically configures and reconfigures the network of AI nodes. The AI nodes may be arranged such that they process data in series, in parallel, iteratively, in branches, with skipping, and the like. In some embodiments, the software application may dynamically alter the status of an AI node, for example, by disabling an AI node and removing it from the network of nodes, activating an AI node and adding it to the network of nodes, modifying an arrangement of the AI nodes, creation of a new AI node using configuration templates and the like. The modularity of the configuration ensures that nodes created in one network can be reused in other networks, and new nodes can be instantiated and integrated in real time when required.

Each AI node may have communication capabilities including the ability to send electronic messages to a user interface, to a computing device, and the like. The AI node may also receive responses to the electronic messages. For example, the responses may include inputs to the user interface, electronic response messages, instructions to robots and other devices and machines, and the like. Each AI node may also have the ability to retrieve data from both internal and external data sources including network storage devices, external storage devices, databases, publicly available data sources, websites, and the like. Each AI node may be preconfigured or configured during processing to access one or more particular AI models or dynamically select from a set of AI models. As an example, response generation and response validation may have two AI models being used within the same AI node. The preconfiguring may be performed in advance or at the time of execution. In some embodiments, nodes may retrieve information from databases using reference mechanisms such as metadata labels, index keys, semantic tags, or linkage identifiers. These mechanisms provide a standardized way to access and interpret stored information, ensuring that nodes can consistently locate the correct data objects during execution.

Each AI node, or node, may be capable of receiving input, performing processing of a task, generating an output, transferring the output, and the like. The modular and configurable design enables the software to create different arrangements of AI nodes. The AI nodes may be arranged in different formations, with different rules, different AI models, and the like. For example, AI nodes may be arranged to branch, to synthesize outputs, or to loop within themselves or across other AI nodes and may process information from multiple heterogeneous sources while seamlessly interoperating between individual AI nodes, groups of AI nodes, and external AI management systems. The dynamic management of networked AI Systems replaces traditional static AI training processes with a highly configurable and adaptive network delivering superior performance compared to current AI implementations. The system has the ability to create and place new AI nodes within a network or place in other networks/subnetworks/assistants through node configuration editing module or terminate or disable existing AI nodes and update existing AI nodes within the network. In some embodiments, specialized node types may be defined, including Interpreter Nodes for interactions with humans and external systems, Orchestrator Nodes for dividing multi-step problems and aggregating results, and Iterative Nodes for handling repetitive tasks across sets of homogeneous data objects.

Nodes may be grouped into subnetworks that process similar categories of data, and subnetworks may be connected to one another through linkages. Each linkage may define a connection type, including sequential, parallel, conditional, or iterative. Connections between nodes, subnetworks, and networks may evolve over time based on execution history, context variables, or dynamic reconfiguration, thereby allowing flexible adaptation of network topology. Subnetworks may exchange similar data types, though the system also supports cross-subnetwork exchange of any data or action object as needed.

Linkages may include direct node-to-node connections, subnetwork-to-subnetwork pathways, network-to-network interfaces, node to subnetwork, and node ato network. Connections may evolve over time as the system creates new links, modifies existing ones, or removes obsolete connections based on context and history. Linkages may be conditional, role-based, or dynamic, thereby enabling flexible collaboration across nodes and networks.

If a determination needs to be made by the system, then a node is needed with the AI Systems for example, large language models (LLMs) or any other non-text-based AI model, and hereafter referred to as AI Systems, to make that determination. Each node in the network may include a different AI System and different configurations of the AI systems performing the same task. The system may use clarifying / validating questions to find out what specific nodes need to be instantiated, it may go through history, it may go through templates, and the like. It may say in a second iteration, this was a problem in the first iteration and try again and then it evaluates the result in this second iteration and continues to determine whether the problem has been solved. If not, it can keep looping and the system may create questions that are sent to a user to stop the loop from continuing. For example, if the loop goes at least 3 times, the system may then decide to generate a question based on the programming. Or maybe it uses a period of time (3 seconds, 5 seconds) and then decides to ask a question. This system allows for dynamic and conditional prompt engineering which is created through multiple steps or iterations which can include both AI and deterministic processes. Iterations may be applied at the subnetwork level, across multiple nodes, or within individual nodes, and may be governed by configurable thresholds that prevent infinite looping while still enabling iterative refinement of solutions.

Iteration may occur within a single node, across a subnetwork, or across an entire network. Iteration may be controlled by conditions such as maximum cycle count, elapsed time, or solution quality thresholds. Specialized nodes may be employed to handle particular roles in iterative or multi-step processes. An interpreter node may manage interaction with humans, external systems, or APIs by formulating and transmitting queries and receiving and interpreting responses to modify internal variables, prompts or information accordingly. An orchestrator node may divide a multi-step problem into sub-tasks, assign the sub-tasks to nodes, and aggregate and summarize results. An iterative node may repetitively execute the same function or model across a series of homogeneous data objects while combining the outputs into a consolidated result.

The network may blend deterministic functions and AI processing. Artificial intelligence components may handle semantic analysis, intent identification, task categorization, or contextual reasoning, while deterministic components may perform structured data retrieval, mathematical operations, or rule enforcement. This blending allows the system to assign reasoning tasks to AI while reserving deterministic logic for structured, repeatable tasks, thereby increasing overall accuracy and efficiency.

When you have multiple AI systems in one node, it can use one AI system but make it use different variables in different configurations within the same node or multiple AI systems with the same or different configurations. The configuration and prompt(s) may indicate the equivalent of “Try this and give me all ten outputs. Out of these outputs, pick the ones that are similar and combine them into one solution, and then list the ones that you picked.” The next node might be configured to say the equivalent of, “of the ones selected, select the best based on the problem I have, I’m going to make a rule to only use these AI selections and AI configurations as the best configuration to solve this type of problem in the future. In this scenario it can evaluate which solution is best and try the solution 10 different ways by configuring an AI system 10 different times. So, each node could have AI systems or the same systems with different configurations or a mixture of the two being used for slightly different purposes.

Certain nodes may be configured as transformational layers to translate between human-readable inputs, artificial intelligence-readable prompts, and computer-readable structured data formats such as JSON. By enforcing translation layers, the system prevents degradation of information as it flows across heterogeneous components and ensures that inputs from humans, machines, and AI models are all interpreted correctly.

In some embodiments, the feedback about which AI System or System configuration works the best may be provided from the originator who requested the request. In this case, the user may say this was a good solution, and in response, the system can use the same solution each time a similar problem occurs for this end user. Feedback from users can also be analyzed by the same or another Network to optimize the configuration of a network in other ways.

“Given the answer that you have, what would have been a better prompt than the following….” This is another thing the system can ask the end user and use to self-learn. The system could also suggest better prompts and get the user’s inputs. As it continues to communicate with the originator / end user, it is improving itself by honing things like prompts, templates, AI System configurations, AI System selections, etc. These types of functions could be implemented as subnetworks or specialized networks or assistants to monitor, analyze and tune a network's inputs and outputs for improvement.

A problem / task could be sent to multiple nodes at the same time where each of the nodes are assigned different roles. Each node may then produce a different plan / solution for a different step of the problem based on the role. A combiner node then receives all of the different plans / solutions and combines them into a full plan that is output to the originator or to the next node / network. This entire plan could then be executed in one sweep. For example, the system may receive a new problem and look at similar problems the system has solved in the past, and create a multi-step plan and combine it, and execute each step of the multi-step plan.

Adding new nodes to the network is also part of the system. The system can determine the steps needed for a problem and then assign nodes for each of the steps.

The system can be used for taking physical actions in addition to performing information gathering and data manipulation. For example, the system may be used to drive vehicles, update data stored in a database, send network communications, generate images, display the generated images, control functionality of a robot, and many others. For example, the system may communicate with an actionable object, such as a robot, vehicle, database, etc., by sending it instructions through network communications, by controlling it through wireless commands, by sending it data such as data for storage in a database table, etc.

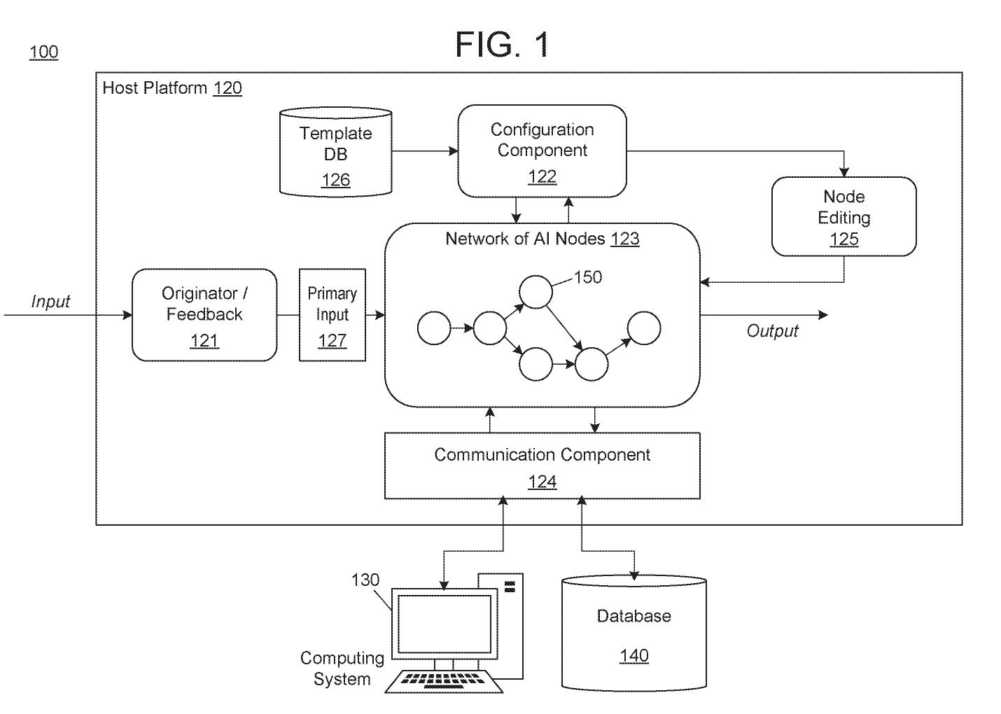

FIG. 1 illustrates a system 100 for processing tasks using a network of AI nodes according to an embodiment of the instant solution. Referring to FIG. 1, a host platform 120 may host a network of AI nodes 123 including a plurality of AI nodes 150 that are interconnected and configured for performing AI processing tasks. The network of AI nodes 123 may be configured differently with nodes arranged in different patterns, numbers, etc., depending on task type, input data types, model types, and the like.

In this example, the host platform 120 also hosts an originator component 121 configured to receive input from a user device and provide an input to the network of AI nodes 123. The host platform 120 also hosts a configuration component 122 that dynamically configures the number, pattern, interconnections, etc. among the AI nodes within the network of AI nodes 123. Furthermore, the configuration component 122 may also modify the configuration of the network of AI nodes 123 through a node editing component 125. The host platform 120 may also host a communication component 124 that is configured to communicate with external devices (e.g. over a network), databases (local, external, public, etc.), websites, electronic messaging systems, and the like.

The originator component 121, the configuration component 122, the node editing component 125, the network of AI nodes 123, and the communication component 124 may be hosted together in a software application. For example, each component may be a microservice or set of microservices, however, embodiments are not limited thereto.

In this example, a user or system may request a processing task be performed that involves execution by one or more AI models. In this example, the originator component 121 may receive the request for the processing task and determine a primary input 127 for the network of AI nodes 123. The primary input 127 may include an identifier of a task to be performed, an identifier of an AI model, multiple AI models, input data, output format, and the like. The primary input 127 may be used by the configuration component 122 to initially configure the AI nodes in the network of AI nodes 123. This configuration may be initially determined by metadata that the network can both read and alter. Here, the configuration component 122 may determine a number of AI nodes, an arrangement of the AI nodes, interconnections among the AI nodes, sub-tasks for the AI nodes, and the like. In some embodiments, the configuration component 122 may use a network template stored in a template database or metadata store 126. The network template may identify a number of existing AI nodes, interconnections among the AI nodes, sub-tasks, AI models, etc. The network template may be mapped to a task type of the AI task.

Once the network of nodes is configured, the network of AI nodes 123 may execute on the input data within the primary input 127 and generate an output. During executing, the AI nodes 150 within the network of AI nodes 123 may interact with computing devices 130 such as personal computers, mobile devices, email systems, electronic messaging systems, etc. As another example, the AI nodes 150 within the network of AI nodes 123 may interact with storage systems 140 including, but not limited to, databases, local data stores, external databases, websites, metadata stores and the like. Metadata may be provided in addition to node configurations. This metadata can include descriptions of information which a network is likely to encounter, along with rules on how to process that data and how that data is connected. These descriptions enable pre- and post-processing to be more flexible and dynamic. This store of meta information which a network is likely to encounter can also be modified by AI networks though rules can be added to limit its ability to modify in some cases. This meta can be extended to also store the deterministic functions in both pre- and post- processes as well. Meta information can be defined and organized at multiple levels including but not limited to Node level, Network Level, System Level, Connection/Linkage, Procedural, and Semantic level. This enhances the modularity and flexibility of the system to reuse the same components for different problem types.

The system may include self-modification capabilities. Self-modification may comprise creating, adding, or modifying nodes during a single iteration, during a network cycle, or on a permanent basis. Metadata defining validation rules, assumptions, or problem-solving strategies may be dynamically altered by nodes or subnetworks. Such modifications may occur in response to past feedback, business rules, user input, data encountered during execution or programmed conditions. Metadata and configurations may also be modified by administrators or users, or automatically by nodes or network managers during runtime. Network managers are components that oversee the configuration, execution flow, and structural evolution of a network of AI nodes, including the creation, removal, or modification of nodes, subnetworks, linkages, and metadata. These managers apply deterministic rules, monitor execution history, and enforce governance policies to ensure that dynamic changes to the network occur in a controlled and structured manner. Self-modification may extend to business rules, security rules, data models, objects in use, metadata handling, linkages between nodes and subnetworks, execution flow, pre-processing tasks, post-processing tasks, input and output formats, and user interaction logic. The system may further create nodes from templates, add subnetworks, call specialized nodes conditionally, and connect to external networks as part of its self-modifying behavior. Modifications may be limited or conditional, requiring approval from another network, from an oversight module before application, and/or an originator or admin.

In some embodiments, artificial intelligence components may contribute to modification decisions by generating recommendations, adjusting parameters, or tuning metadata based on observed patterns, feedback, or execution results. However, the system applies and enforces these modifications through defined configuration managers, node editing components, or metadata repositories, thereby distinguishing the disclosed approach from autonomous agent frameworks. A configuration management node is a specialized AI node that performs control and oversight functions for modifying the structure, linkages, and roles of nodes and subnetworks within the AI network. This node applies deterministic configuration logic, accesses and updates metadata repositories, and enforces operational rules based on execution feedback, system context, or stored templates to manage the dynamic evolution of the network. Modifications initiated by AI contributions may be subject to deterministic rules, approval processes, or oversight by other networks before they are committed, ensuring that the modification process remains controlled and structured rather than agentic in nature.

According to various embodiments, the AI nodes 150 within the network of AI nodes 123 may execute in sequence, in parallel, in timed intervals, in stages, in a specific order, based on triggers, conditional selections, etc. The order of execution may be controlled by the configuration of the AI nodes 150. In some embodiments, the execution may be an iterative process requiring multiple loops performed by the network of AI nodes 123. In this case, the AI nodes 150 may be modified by a node editing component 125 which may edit existing AI nodes in the network by modifying at least one of input data, functionality, AI model, task, and the like. In further embodiments, iteration may occur at different levels of granularity, including iteration across a subnetwork of nodes, or iteration across the entire network of AI nodes 123.

In some embodiments, the system may instantiate new nodes from a pool of deterministic functions, wherein the pool may be updated in real time to incorporate additional deterministic functions as required. Nodes created from deterministic functions may be reused across different networks or subnetworks without reconstruction, and groups of nodes may be arranged, dismantled, and rearranged to form new networks dynamically. Each function, node, and network may define standardized input and output mappings to ensure that configurations remain interoperable when reused or rearranged. The system may further act on heterogeneous data and action objects originating from diverse sources, such as text, structured database records, executable instructions, or robotic commands, wherein each object type is routed through a transformation pipeline and an execution pipeline specifically configured for that type. Action objects refer to structured entities that trigger or represent executable operations within the AI network, such as robotic commands, API calls, database updates, or signal transmissions. These objects may originate from diverse sources including user inputs, external systems, or internal workflows, and are processed by AI nodes to initiate specific tasks or responses.

In addition to dynamic configuration, the system may operate in a fixed pipeline mode in which the sequence of nodes is predefined and remains constant for each execution. This static mode allows the network to process inputs in a consistent, repeatable manner without requiring reconfiguration, which may be advantageous for well-defined tasks.

The ability of the system to dynamically configure, reconfigure, and evolve its structure during execution is a core aspect of its design. Dynamism enables the network to adapt processing pipelines, linkages, and subnetworks in real time, thereby ensuring that the system remains flexible and responsive to diverse and changing task requirements.

The initial configuration of AI nodes, assistants, networks, subnetworks, and the like, within the network is done before processing and is used to determine the order of processing, security protocols, initial input processing and final output processing. The configuration of each node in the network and any templates, prompts or other information in data sources is also set up to determine the logic and processing in each node. The nodes may have multiple processing stages therein including pre-AI processing, AI processing, and post-AI processing. This will be done either at the data level or on a configuration interface. After the network is configured, a step-by-step process may be as follows, however, embodiments are not limited thereto. "The system also supports conditional execution and dynamic prompt engineering based on observed criteria, user input, guarded operations or known predicated rules encountered during runtime, which are created through multiple steps or iterations that can include both AI and deterministic processes"

Step 1: Receive an initial request or requests from one or more originators.

Step 2: Generate a “primary request” from the initial request or requests. The Primary Request may be a simple concatenation of the initial requests and have information about originators, originator history, originator role and a reference ID to the conversation.

Step 3: The originator may select a network, assistant or subnetwork to use. If not, the Primary Request will be sent to an assistant, network or subnetwork whose purpose is to route the Primary request to a well-suited assistant, network, or subnetwork. Regardless of which approach is taken, the processing steps in the network at the node or node level will be the same.

Step 4: The Primary Request is sent to one or more initial nodes in the assistant, network or subnetwork that the Primary Request is routed to. The Primary Request is received as a Primary Input by each of the initial nodes in the Assistant, network or subnetwork it is routed to.

For each node receiving a Primary Input in the collection of nodes in the selected assistant, network or subnetwork, the same process (Step 5) takes place.

Step 5: Processing in each of the network nodes:

The Primary Input or Inputs are received by the node. Based on the node configuration they are combined into a Primary Input based on determinations or AI algorithms/subroutines which could involve other nodes in the network.

### Pre-AI Processing Stage

The Pre-AI Processing Stage of the Node or Node takes all primary inputs and can in one or more steps combine, alter or perform transformations on the primary inputs. The input to the pre-processing stage is derived from the node input and may include a subset or transformation of context variables, data objects, and routing metadata as defined by the node configuration. This can include transformations involving other nodes in the network, deterministic algorithms and/or acquiring information from other sources (e.g., network history, database information, PDFs, etc.). The data sourcing could involve retrieval augmented generation (RAG), database queries, etc. Other content added in this process may involve AI prompting templates or other context related information. Variables may be used in content in one step which are then provided values by future steps or even future stages or AI nodes. The exact order and logic which the steps within the Pre-AI Processing stage take place will be determined by the configuration of the node. The data sources may include databases, sensors, IoT devices, text chats, emails, etc., or systems such as another subnetwork which could carry out a conversation with a human operation or automated system to synthesize a final input into the current AI node’s pre-AI processing stage.

One result of the pre-processing stage is to create an AI Payload which will contain an AI Prompt, selection of AI systems to send the prompt to and the configuration for each AI system to be sent a payload. The same prompt will be sent to all AI systems. The reason for the option of the multiple AI systems is to provide the option of comparing or combining AI systems answers in future stages or in future AI nodes or nodes.

### AI Processing Stage

The AI Payloads are sent to the AI systems and return an AI Generated Output from each AI System in the AI Processing Stage.

### Post-AI Processing Stage

E.The AI Generated Outputs go through a Post-AI Processing stage. The Post-AI Processing Stage of the Node takes all AI Generated Outputs and can in one or more steps combine, alter or perform transformations on the AI Generated Outputs. This can include transformations involving other nodes in the network, deterministic algorithms and/or acquiring information from other sources (e.g., network history, database information, PDFs etc.). The data sourcing could involve RAG, database queries etc.). Other content added in this process may involve AI prompting templates. Variables may be used in content in one step which are then provided values by future steps or even future stages or AI nodes. The exact order and logic which the steps within the Post-AI Processing stage take place will be determined by the configuration of the node or Node. The data sources may include databases, sensors, text chats, emails, etc., or systems such as another subnetwork which could carry out a conversation with a human operation or automated system to synthesize a final output from the post-AI processing stage.

The result of the Post-AI Processing Stage is one or more Node Outputs and a destination for each Output.

a. Destinations may include
i. The Node Configuration Editing Component with the output providing instructions as to what nodes in the network to add or edit. This would be processed before the other outputs. This could be nodes inside this assistant, network or subnetwork or nodes in other assistants, networks or subnetworks inside the current system or in another AIMS Systems.
ii. The same AI node which is processing this loop.
iii. An AI node earlier in the network / subnetwork or Assistant to form an iterative look of multiple AI nodes or Nodes.
iv. AI node later or at the same processing level as the current Node.
v. The originator component and originator to serve as part of the whole of the final output or the final output. The originator component may wait on other processes before providing the final output to the originator.
vi. The originator component and originator to acquire more information and then provide a destination for that response.
vii. An external system to acquire information or a response and a destination for that information or response or simply as a system output which may or may not be the final output of the system.
viii. Other nodes in the network but the destination is not the primary input but an input into the pre-processing or post-processing stage (typically this would result from a request in one of these stages and return as a result of that query).
ix. External AAIMS systems and assistants, network or subnetworks and nodes/nodes within those networks in those systems if security permissions have been given.
x. The security components of the AIMS systems.
xi. History saving component

b. Choice of Destinations may be influenced by (but is not limited to):
i. Input data from data sources
ii. Conditions based on history of originator feedback, prior destinations, and system analysis of past performance.
iii. Configuration of the network
iv. Conditional logic based on node output
v. Whether new destinations have been created during the node or network cycle
vi. Type of problem
vii. Changes in Default Assumptions
viii. Originator Input or Immediate Interaction

Step 6: The next node(s) or cell(s) if any are processed in the same manner as above.

Step 7: When all final outputs have been provided as determined by the network configuration, the processing for this assistant, network or subnetwork is complete for this network cycle. The originator component delivers the final output, generated by the network of AI nodes, to one or more designated destinations, including external systems, human interfaces, or persistent storage, as defined by the network configuration.

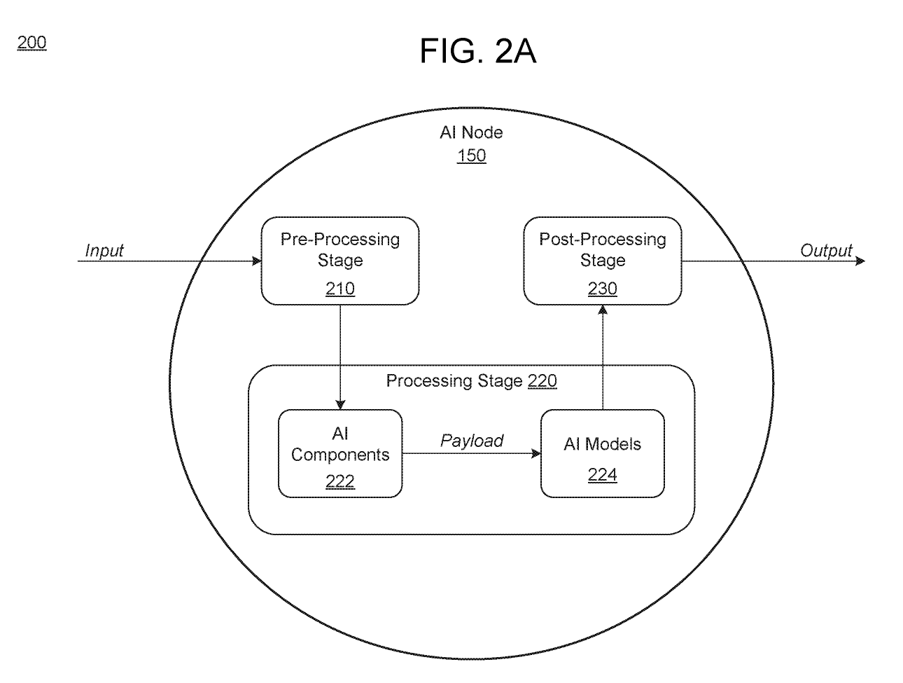

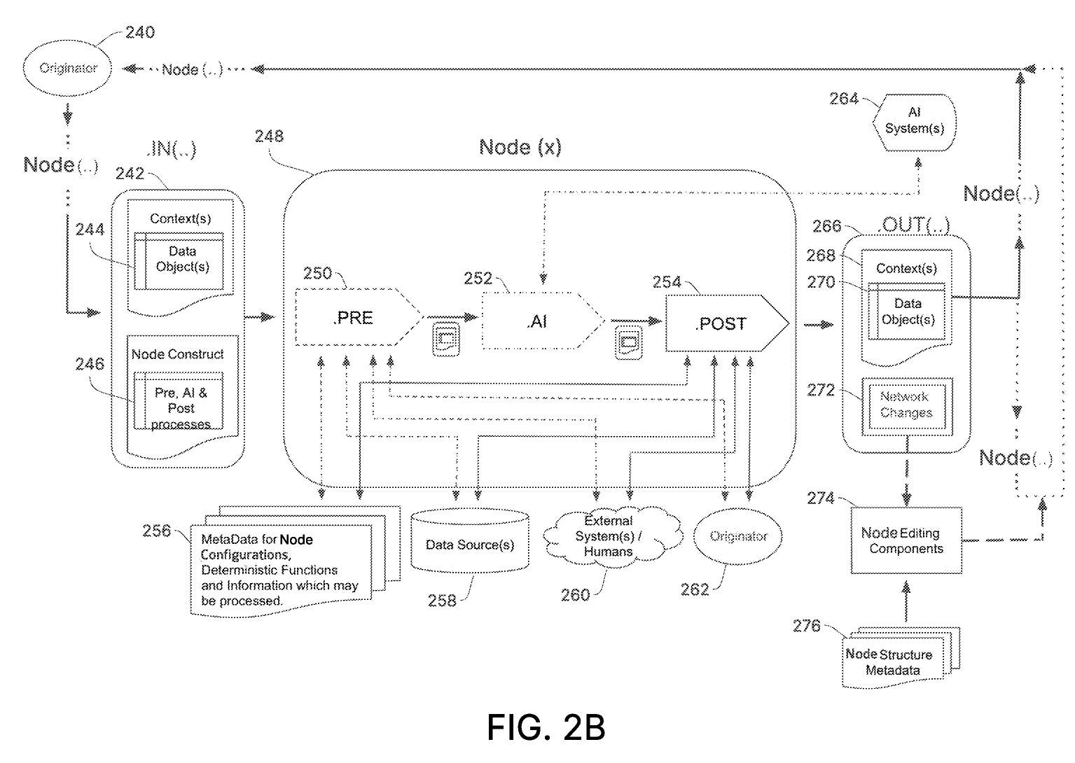

FIG. 2A illustrates a view 200 of an AI node 150 which may be included in the network of AI nodes of FIG. 1, according to an embodiment of the instant solution. Each AI node in the network of AI nodes 123 may contain a common architecture as each other. For example, the AI node 150 may include a pre-processing stage 210, a processing stage 220, and a post-processing stage 230 and metadata providing some or all node structure, deterministic functions and processing. The pre-processing stage 210 may receive an input from another AI node, a software application, a device, a user interface, and the like, and convert the data into a format that matches an input format of an AI model used during the processing stage 220.

In this example, the processing stage 220 includes execution of one or more AI models 224 based on input data, and AI components 222 which can facilitate the execution of the one or more AI models 224. For example, the AI components 222 may obtain input data from storage systems, may query users / user devices, may interact with other software, systems, etc. The processing may include executing a sequence of AI models where outputs from at least one of the AI models in the sequence is input to another AI model in the sequence. The post-processing stage 230 may take the output from the one or more AI models 224 and store the output, display the output on a graphical user interface (GUI), query a user / user device, and the like. The post-processing stage 230 may also identify a next AI node or nodes in the network and transfer an output to the next AI node or nodes in the network.

AI to AI communication may be enabled in the instant solution through the structured exchange of outputs and inputs between AI nodes 150, where each AI node may include one or more AI System configuration operating within the processing stage 220. The pre-processing stage 210 of a first AI node may format a predictive output into a structured prompt or data payload suitable for execution by an AI System in a subsequent AI node, and the post-processing stage 230 may determine appropriate routing of that output to a destination node based on task logic defined by the configuration component 122 of FIG. 1. In some embodiments, the output from a first AI System may be stored in a shared data store or template database 126 using uniquely identifiable tags or metadata, which may then be queried by the pre-processing stage of a downstream node as part of its input generation routine. These database tags may act as semantic identifiers that associate outputs with their originating nodes, their roles, or context within a larger workflow, enabling precise control over which responses are reused, refined, or synthesized by subsequent AI System instances. As such, the dynamic configuration of AI nodes into sequential or parallel arrangements allows one AI System's processed output to be interpreted, transformed, stored with contextual tagging, and later retrieved and injected, and used as the input prompt for another AI System instance, enabling multi-stage reasoning, iterative refinement, and role-based collaboration between distinct AI Systems within the network of AI nodes 123.

In some embodiments, the AI System-to-AI System communication may utilize a semantic tagging framework such as the Resource Description Framework (RDF) or a similar metadata system to enable structured and machine-interpretable exchange of data between AI nodes. Under this approach, outputs from an AI System operating within an AI node 150 may be transformed into metadata system that describe the content, context, and intended role of the output. These metadata system may be stored in a knowledge graph or datastore accessible by other AI nodes in the network of AI nodes 123, allowing downstream AI Systems to query specific semantic elements of prior outputs using query languages. For example, a second AI node may retrieve prior reasoning results based on predicates such as "hasConclusion", "supportsClaim", or "relatesToEntity" to dynamically construct a prompt grounded in the contextual knowledge established by an earlier node. The metadata system-based communication model allows each AI System to both contribute to and extract from a structured, evolving representation of the task, thereby enabling rich, interpretable, and role-specific dialogue between AI models across the network.

In some embodiments, the nodes may transfer objects between themselves as a novel method to allow AI systems to understand application processes and the equivalent of ‘screens’ when communicating with application databases or APIs. Data passed from node to node can have many formats include data frames, images, audio, etc. One novel format for some system configurations is that of utilizing a text-based Data Object to allow AI systems to ‘visualize’ and ‘understand’ data from a database particularly those representing complex workflows and user screens. An AI system cannot ‘see’ a screen efficiently and if it did it may not ‘understand’ the labels. This method addresses that issue. A Data Object is text based but sourced from a database in such a way as to simulate a screen layout a human user might see using an application designed to allow him or her to enter, edit and otherwise that data. The data object configuration may contain a primary table, look up tables, and sub tables as well as fields in each. When executed the raw data from a database, API or other data source will be combined with a single- or multi-layer template designed to show the data object in a way which is explanatory to the AI System, contains references to allow the AI inquire further about specific fields and data and, if applicable, where that object is in a workflow inside a larger application. The data object configuration will contain data and references to further explain fields and data within the object , the business rules which allow or disallow changes in the data to be based on the workflow state the data object is in and the methods such as APIs or database update command templates that allow the data to be altered. This will allow an AI system to analyze data within other applications and mirror business rules and processes in those applications as well as provide safe methods for requests to change the data to be safely processed as well as to respond to queries about the data.

In some embodiments, the system may perform an iterative method in some configurations for nodes to process inputs and store outputs as well as execute recursive outputs to previous nodes in a network is as follows: One Possible Method for process to process nodes recursively to facilitate branches, loops and iterations within and between nodes. Data Outputs from nodes or originators / originator objects may be stored in a data structure such as a database along with their destination objects (nodes, originator objects/originators, external systems, etc.), a reference to or indicator of the destination node’s segment / column within the network (order of operations for the node segments and individual nodes) and whether or not that output has been processed or has begun to be processed in its destination objects. For each column of the network whose nodes are to be processed, the network management system would first check to see if there are unprocessed outputs destined for the earliest column/stage in the network. It would then instruct the earliest network objects to process those outputs as inputs (combining any multiple inputs into a single primary input for each destination node). After the processing of the nodes in a network segment, there would be another check to determine if there are now, after the first process, still outputs to be processed at this earliest column / stage since those most recent outputs could be iterative. Once there are no more inputs to be processed at the earliest stage/column then the network management would cause and items in the next column after the earliest column to be processed if there are any to be processed. After this process, the network management would check again for outputs to earliest network segment. This iterative and recursive process would continue until there are no more destinations except for final output destinations in the data store of network outputs for this particular instance of the subnetwork, network or assistant. This process could result in infinite loops, and it will be up to configuration and prompt engineering of the nodes in the network to prevent these potential infinite loops such as with limits iterations, exceptions, branch logic etc. or branches to other network segments if an iterative or recursive limit is reached or other similar logic.

FIG. 2B illustrates an example configuration of an AI processing node (Node(x)) 248. The node 248 receives input information from one or more originators 240 or from preceding nodes in a network. An input structure 242 may include at least one context 244 and at least one data object 244. The input structure 242 may also include a node construct 246 specifying pre-processing, AI-processing, and post-processing functions to be applied by the node 248.

The node 248 comprises a pre-processing stage 250, an AI-processing stage 252, and a post-processing stage 254. The pre-processing stage 250 is configured to receive input from the input structure 242 and to perform transformations, normalizations, or combinations of the context(s) and data object(s). The pre-processing stage 250 may access metadata 256 describing node configurations, deterministic functions, and information types that may be processed. The pre-processing stage 250 may also retrieve external data from data sources 258, external systems or humans 260, or originators 262 to enrich the primary input.

The AI-processing stage 252 is configured to execute one or more AI models based on the transformed input. The AI-processing stage 252 may include a selection of AI models, large language models, neural networks, or deterministic subroutines. The execution of these AI models generates predictive outputs that are forwarded to the post-processing stage 254.

The post-processing stage 254 is configured to receive the predictive outputs from the AI-processing stage 252 and to perform transformations, filtering, synthesis, or formatting. The post-processing stage 254 may also incorporate additional metadata 256, data from data sources 258, responses from external systems or humans 260, or information provided by originators 262 to refine the predictive outputs.

The processed output from the post-processing stage 254 is delivered to an output structure 266. The output structure 266 may include at least one context 268 and at least one data object 270, as well as network configuration changes 272 determined by the execution of the node 248. The output structure 266 may provide information to downstream nodes, external AI systems 264, or back to the originator 240.

The configuration of the node 248 may be dynamically modified by node editing components 274. The node editing components 274 are configured to alter pre-processing, AI-processing, or post-processing functions of the node 248 based on execution results, metadata feedback, or instructions from originators 262. The node editing components 274 may use node structure metadata 276 to define allowable changes, constraints, or template-based modifications to the node 248.

Through the combination of the input structure 242, the node construct 246, the pre-processing stage 250, the AI-processing stage 252, the post-processing stage 254, the output structure 266, and the associated metadata and editing components 256, 274, and 276, the node 248 operates as a modular and configurable processing unit. The node 248 can iteratively exchange context(s), data object(s), and network changes with other nodes in a network, thereby enabling the construction of dynamically reconfigurable subnetworks of AI nodes that support modular, conditional, and multi-step task processing.

In addition to the components described above, FIG. 2B also illustrates the role of standardized context variables within the node 248. The input structure 242 may provide at least one context 244, and the output structure 266 may include at least one context 268. Each context 244, 268 may represent a standardized context variable, which contains both descriptive metadata about the type of information being processed, and one or more values generated or transformed during processing. The standardized format of the context variable enables consistent interpretation and propagation of information across the pre-processing stage 250, the AI-processing stage 252, and the post-processing stage 254.

The context variables may evolve during the lifecycle of a request, being updated or extended as intermediate outputs are produced within the node 248. For example, the post-processing stage 254 may append metadata to a context variable describing the reliability of an output, while the AI-processing stage 252 may insert inferred semantic tags or embeddings. These modifications are stored within the standardized format to ensure downstream nodes can parse both the content and its descriptors.

The standardized format allows interoperability across nodes, subnetworks, and networks by ensuring that outputs from the output structure 266 match the expected inputs of other nodes or systems. For instance, when data is passed from the output context 268 to the input context 244 of a downstream node, the predefined format guarantees that the receiving node can directly interpret the transmitted values and descriptive metadata. The context variables may further include temporal attributes, linkage references to related data objects 270, and indicators of processing history, thereby enabling traceability of decisions and transformations across the network.

The system enables dynamic and configurable propagation of information between nodes 248, subnetworks, and networks via integration of standardized context variables into the input structure 242 and output structure 266.

The standardized context variables, node editing components, and evolving linkages, configurations and deterministic programming collectively emphasize the dynamism of the system, which is fundamental to its operation. Unlike static AI pipelines, the disclosed architecture is inherently dynamic, allowing its topology, data flows, and processing functions to change over time in response to task context and execution feedback.

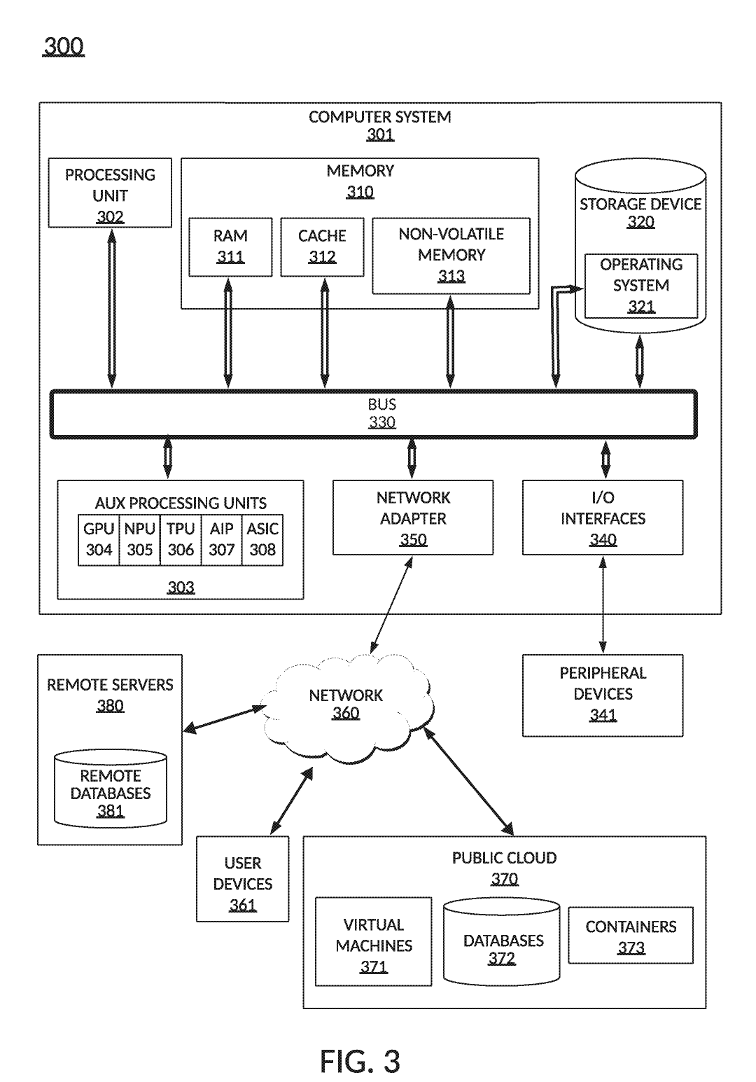

The examples and features of the instant solution may be implemented in at least one of the elements described or depicted herein, including for example, the elements described or depicted in FIG. 3. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 3 illustrates an example computer system architecture, which may represent or be integrated in any of the above-described components, etc.

FIG. 3 illustrates a computing environment according to the instant solution's example features, structures, or characteristics. FIG. 3 is not intended to suggest any limitation as to the scope of use or functionality of features, structures, or characteristics of the instant solution of the application described herein. Regardless, the computing environment 300 can be implemented to perform any of the functionalities described herein. In computing environment 300, there is a computer system 301, operational within numerous other general-purpose or special-purpose computing system environments or configurations.

Computer system 301 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 360 or querying a database. Depending upon the technology, the performance of a computer-implemented method may be distributed among multiple computers and among multiple locations. However, in this presentation of the computing environment 300, a detailed discussion is focused on a single computer, specifically computer system 301, to keep the presentation as simple as possible.

Computer system 301 may be located in a cloud, even though it is not shown in a cloud in FIG. 3. On the other hand, computer system 301 may not be in a cloud except to any extent as may be affirmatively indicated. Computer system 301 may be described in the general context of computer system-executable instructions, such as program modules, executed by a computer system 301. Generally, program modules may include routines, programs, objects, components, logic, data structures, and so on that perform tasks or implement certain abstract data types. As shown in FIG. 3, computer system 301 in computing environment 300 is shown in the form of a general-purpose computing device. The components of computer system 301 may include but are not limited to at least one processor or processing unit 302, a system memory 310, and a bus 330 that couples various system components, including system memory 310 to processing unit 302.

Processing unit 302 includes at least one computer processor of any type now known or to be developed. The processing unit 302 may contain circuitry distributed over multiple integrated circuit chips. The processing unit 302 may also implement multiple processor threads and multiple processor cores. Cache 312 is a memory that may be in the processor chip package(s) or located "off-chip," as depicted in FIG. 3. Cache 312 is typically used for data or code accessed by the threads or cores running on the processing unit 302. In some computing environments, processing unit 302 may be designed to work with qubits and perform quantum computing.

The Auxiliary Processing Units (APU) 303 may contain at least one Graphics Processing Unit (GPU) 304, Neural Processing Unit (NPU) 305, Tensor Processing Unit (TPU) 306, AI Processor (AIP) 307, or other Application Specific Integrated Circuit (ASIC) 308. The at least one APU 303 may contain circuitry distributed over multiple integrated circuit chips. Each APU 303 may implement multiple processor threads and multiple processor cores. Each APU 303 may include at least one of onboard memory, onboard memory cache, and onboard instruction cache. Each APU may be communicatively coupled to the system bus 330 and configure to communicate with other system components, including a processing unit 302, system cache 312, RAM 311, non-volatile RAM 313, operating system 321, Network adapter 350, and Input/Output interfaces 340. In some computing environments, at least one of the at least one APU 303 may be designed to work with qubits and perform quantum computing.

Memory 310 is any volatile memory now known or to be developed in the future. Examples include dynamic random-access memory (RAM) 311 or static type RAM 311. Typically, the volatile memory is characterized by random access, but this may not be the characterization unless affirmatively indicated. In computer system 301, memory 310 is in a single package. It is internal to computer system 301, but alternatively or additionally, the volatile memory may be distributed over multiple packages and/or located externally with respect to computer system 301. By way of example, memory 310 can be provided for reading from and writing to a non-removable, non-volatile magnetic media (shown as storage device 320 and typically called a "hard drive"). Memory 310 may include at least one program product having a set (e.g., at least one) of program modules configured to carry out the functions of various features, structures, or characteristics of the instant solution of the application. A typical computer system 301 may include cache 312, a specialized volatile memory generally faster than RAM 311 and generally located closer to the processing unit 302. Cache 312 stores frequently accessed data and instructions accessed by the processing unit 302 to speed up processing time. The computer system 301 may also include non-volatile memory 313 in the form of ROM, PROM, EEPROM, and flash memory. Non-volatile memory 313 often contains programming instructions for starting the computer, including the basic input/output system (BIOS) and information to start the operating system 321.

Computer system 301 may include a removable/non-removable, volatile/non-volatile computer storage device 320. For example, storage device 320 can be a non-removable, non-volatile magnetic media (not shown and typically called a "hard drive"). At least one data interface can connect it to the bus 330. In features, structures, or characteristics of the instant solution where computer system 301 has a large amount of storage (for example, where computer system 301 locally stores and manages a large database), then this storage may be provided by peripheral storage devices 320 designed for storing very large amounts of data, such as a storage area network (SAN) that is shared by multiple, geographically distributed computers.

The operating system 321 is software that manages computer system 301 hardware resources and provides common services for computer programs. Operating system 321 may take several forms, such as various known proprietary operating systems or open-source Portable Operating System Interface type operating systems that employ a kernel.

The bus 330 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 330 is the signal conduction path that allows the various components of computer system 301 to communicate.

Computer system 301 may communicate with at least one peripheral device, 341, via an input/output (I/O) interface, 340. Such devices may include a keyboard, a pointing device, a display, etc.; at least one device that enables a user to interact with computer system 301; and/or any devices (e.g., network card, modem, etc.) that enable computer system 301 to communicate with at least one other computing devices. Such communication can occur via I/O interface 340. As depicted, I/O interface 340 communicates with the other components of computer system 301 via bus 330.

Network adapter 350 enables the computer system 301 to connect and communicate with at least one network 360, such as a local area network (LAN), a wide area network (WAN), and/or a public network (e.g., the Internet). It bridges the computer's internal bus 330 and the external network, exchanging data efficiently and reliably. The network adapter 350 may include hardware, such as modems or Wi-Fi signal transceivers, and software for packetizing and/or de-packetizing data for communication network transmission. Network adapter 350 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 360 is any computer network that can receive and/or transmit data. Network 360 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 360 may be replaced and/or supplemented by LANs designed to communicate data between devices in a local area, such as a Wi-Fi network. The network 360 typically includes computer hardware such as copper transmission cables, optical transmission fibers, wireless transmission, routers, firewalls, switches, gateway computers, edge servers, and network infrastructure known now or to be developed in the future. Computer system 301 connects to network 360 via network adapter 350 and bus 330.

User devices 361 are any computer systems used and controlled by an end user in connection with computer system 301. For example, in a hypothetical case where computer system 301 is designed to provide a recommendation to an end user, this recommendation may typically be communicated from network adapter 350 of computer system 301 through network 360 to a user device 361, allowing user device 361 to display, or otherwise present, the recommendation to an end user. User devices can be a wide array, including personal computers, laptops, tablets, hand-held, mobile phones, etc.

A public cloud 370 is an on-demand availability of computer system resources, including data storage and computing power, without direct active management by the user. Public clouds 370 are often distributed, with data centers in multiple locations for availability and performance. Computing resources on public clouds 370 are shared across multiple tenants through virtual computing environments comprising virtual machines 371, databases 372, containers 373, and other resources. A container 373 is an isolated, lightweight software for running a software application on the host operating system 321. Containers 373 are built on top of the host operating system's kernel and contain software applications and some lightweight operating system APIs and services. In contrast, virtual machine 371 is a software layer with an operating system 321 and kernel. Virtual machines 371 are built on top of a hypervisor emulation layer designed to abstract a host computer's hardware from the operating software environment. Public clouds 370 generally offers databases 372, abstracting high-level database management activities. At least one element described or depicted in FIG. 3 can perform at least one of the actions, functionalities, or features described or depicted herein.

Remote servers 380 are any computers that serve at least some data and/or functionality over a network 360, for example, WAN, a virtual private network (VPN), a private cloud, or via the Internet to computer system 301. These networks 360 may communicate with a LAN to reach users. The user interface may include a web browser or a software application that facilitates communication between the user and remote data. Such software applications have been referred to as "thin" desktop software applications or "thin clients." Thin clients typically incorporate software programs to emulate desktop sessions. Mobile device software applications can also be used. Remote servers 380 can also host remote databases 381, with the database located on one remote server 380 or distributed across multiple remote servers 380. Remote databases 381 are accessible from database client applications installed locally on the remote server 380, other remote servers 380, user devices 361, or computer system 301 across a network 360. An AI/ML model described or depicted here may reside fully or partially on any of the elements described or depicted in FIG. 3.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution’s capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a node phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

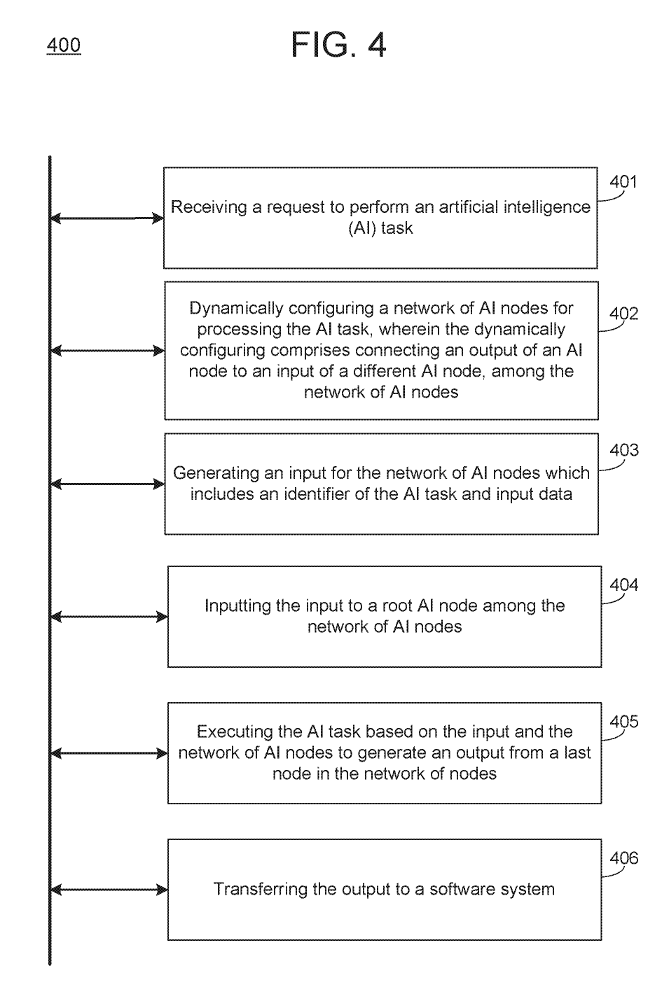

FIG. 4 illustrates a flow diagram of a method 400, according to example embodiments. Referring to FIG. 4, in 401, the method may include receiving a request to perform an artificial intelligence (AI) task. In 402, the method may include dynamically configuring a network of AI nodes for processing the AI task, wherein the dynamically configuring includes connecting an output of an AI node to an input of a different AI node, among the network of AI nodes. In 403, the method may include generating an input for the plurality of AI nodes which includes an identifier of the AI task and input data. In 404, the method may include inputting the input to an initial node among the network of AI nodes. In 405, the method may include executing the AI task based on the input (and optionally, available information) and the network of AI nodes to generate an output from a last node in the network of nodes. In 406, the method may include transferring the output to a software system.

In some embodiments, each AI node may include a pre-processing stage for receiving a predictive output from another AI node among the plurality of AI nodes and converting it into a format that is executable by an AI model of the respective AI node, and a post-processing stage for transferring another predictive output generated by the AI model to another AI node among the plurality of AI nodes. In some embodiments, the method may include receiving a request from an AI node among the plurality of AI nodes and reconfiguring at least one of an order among the plurality of AI nodes and a number of AI nodes included in the plurality of AI nodes based on the request. In some embodiments, the method may include dynamically arranging input / output connections among AI nodes included in the network of AI nodes based on a type of the AI task and sub-tasks to be performed for the type of AI task.

Detailed descriptions of training a machine learning model and executing a machine learning model are further described and depicted herein.

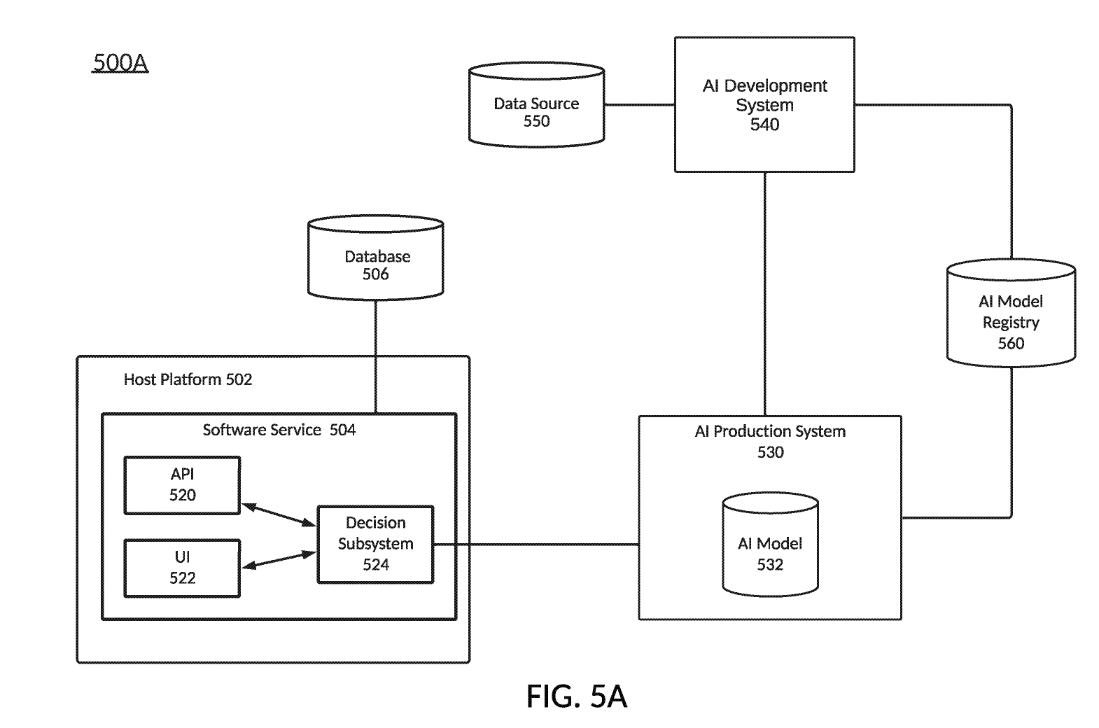

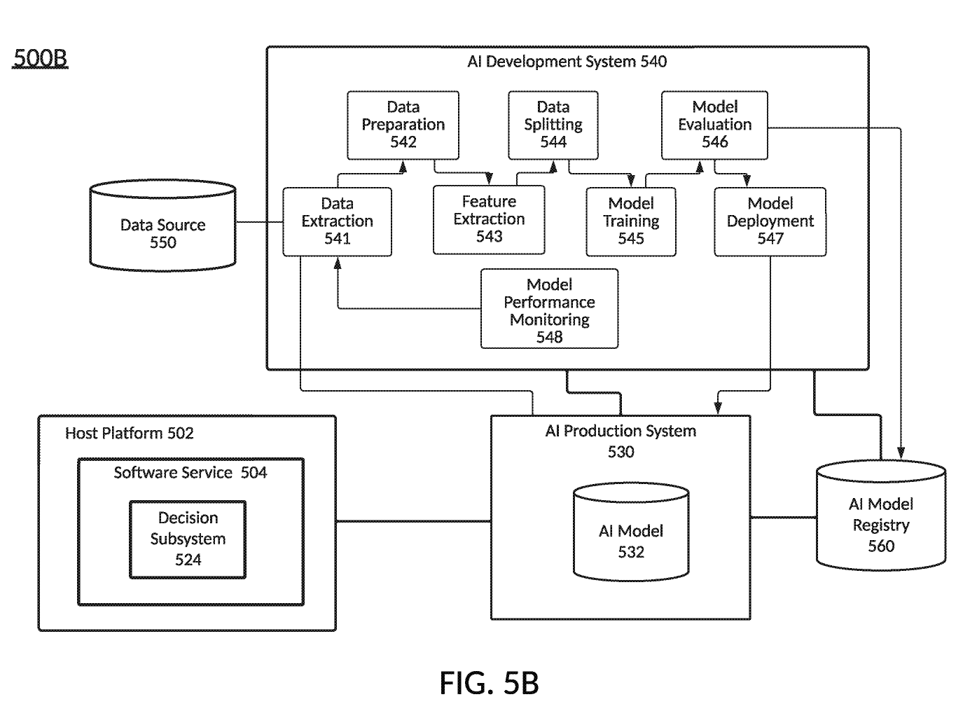

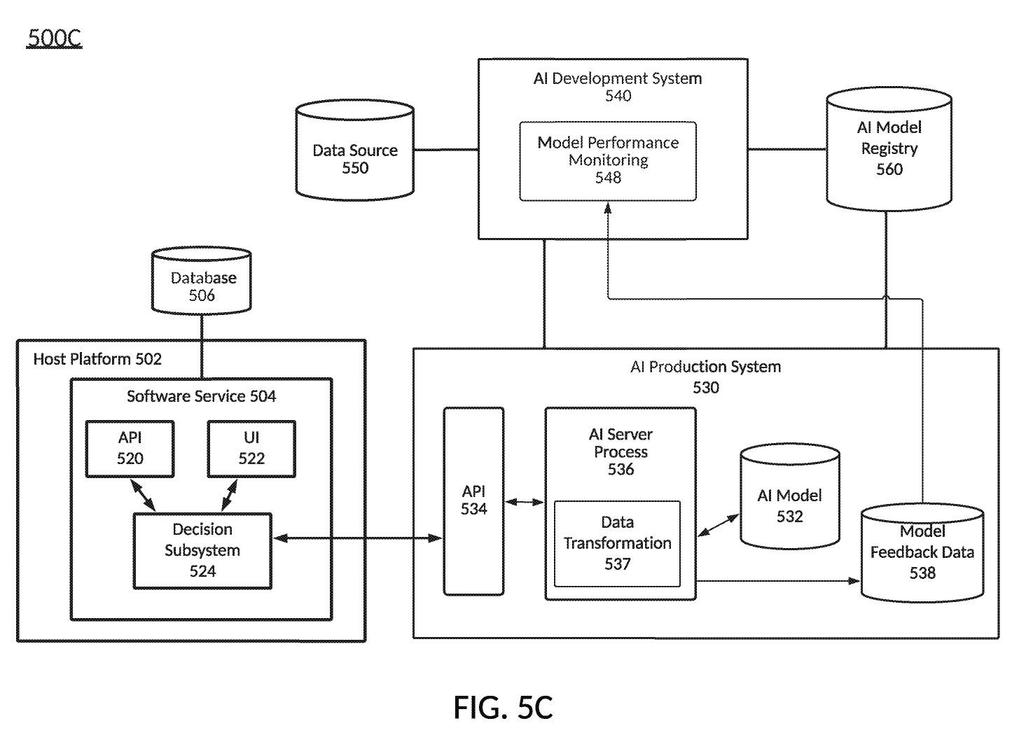

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), other AI system and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as "reactive machines," followed by present-day AI classification "limited memory machines" (also known as "artificial narrow intelligence"), then progressing to "theory of mind" (also known as "artificial general intelligence") and reaching the AI classification "self-aware" (also known as "artificial superintelligence"). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences, 100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on large-scale corpora of textual, multimodal, and domain-specific data, making them capable of understanding and generating natural language as well as structured outputs such as code, tabular data, and symbolic representations to perform a wide range of tasks. LLMs have been implemented at different levels to enhance their natural language understanding (NLU) and natural language processing (NLP) capabilities. This advancement of LLMs has occurred alongside advances in machine learning, training methodologies, optimization algorithms, neural network architectures, and transformer-based architectures that provide the underlying framework for these AI systems. In some embodiments, an LLM may be instantiated within an AI node of the disclosed network and configured as a modular component, allowing substitution, reconfiguration, or integration with deterministic functions and other AI models. This configurability enables the system to tailor an LLM’s role within a subnetwork or across the entire network, thereby blending general-purpose reasoning with domain-specific processing.

LLMs are a class of foundation models, which are trained on large-scale corpora of textual, multimodal, and domain-specific data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance. In some embodiments of the disclosed network, an LLM may be instantiated as the AI model within an AI node, where its configuration can be adjusted to reflect the role, task, or domain context required for a given subnetwork.

LLMs represent a significant breakthrough in NLP and artificial intelligence. LLMs are accessible through interfaces like Open AI’s Chat GPT-3 and GPT-4, which have garnered the support of Microsoft. Each LLM may be integrated as a modular component of a node and combined with deterministic functions, pre-processing, and post-processing logic, enabling blending of reasoning and structured operations.

LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks due to parameters (e.g., billions of) that enable them to capture intricate patterns in language and perform a wide array of language-related tasks. LLMs are revolutionizing applications in various fields, from chatbots and virtual assistants to content generation, research assistance and language translation. When deployed in the disclosed network, these capabilities can be selectively enabled, combined, or constrained by node editing components to fit the specific role of the node within a workflow, ensuring that outputs are shaped by both the model and the configurable task definition.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets. Within a node, the LLM may be wrapped with deterministic routines that guide how embeddings and outputs are interpreted, stored, or transformed into standardized data objects for downstream processing.

During the training process, these models learn to predict the next word in a sentence based on the context provided by the preceding words. The model does this through attributing a probability score to the recurrence of words that have been tokenized— broken down into smaller sequences of characters. These tokens are then transformed into embeddings, which are numeric representations of this context. When integrated into the disclosed system, these embeddings may be stored in metadata repositories or propagated through context variables shared across multiple nodes, allowing subsequent nodes to reuse semantic information generated by the LLM.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive and drawing on the patterns and knowledge they have acquired. The result is coherent and contextually relevant language generation that can be harnessed for a wide range of NLU and content generation tasks. In the disclosed architecture, these outputs may be linked to task-specific configurations of the node, such that the generated content is not only contextually relevant but also structurally aligned with downstream processing requirements, including JSON-formatted objects, API calls, or structured metadata contributions.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents. In the disclosed network, these performance-enhancement methods may be applied at the node level, where the node editing component can adjust prompt templates, apply fine-tuned model variants, or enforce rule-based filters on outputs to reduce undesired behavior while maintaining domain relevance.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats. Within the modular architecture disclosed herein, these diverse capabilities may be selectively enabled, disabled, or combined in different AI nodes, such that one node may perform summarization, another node may handle translation, and a downstream node may enforce deterministic formatting or code validation. This arrangement allows the system to dynamically assign LLM functions based on task requirements, while ensuring outputs remain structured, context-linked, and interoperable with other deterministic and AI-driven components.

LLMs often include abilities such as:

Text generation: language generation abilities, such as drafting emails, blog posts or other mid-to-long form content in response to prompts that can be refined and polished. An excellent example is retrieval-augmented generation (RAG).

Content summarizationsummarize long articles, news stories, research reports, corporate documentation and even interaction history into thorough texts tailored in length to the output format

AI assistantschatbots that answer queries, perform backend tasks and provide detailed information in natural language as a part of an integrated, self-serve solution for handling inquiries.

Code generation:ssists developers in building applications, finding errors in code and uncovering security issues in multiple programming languages, even “translating” between them.

Sentiment analysisanalyze text to determine a user’s tone in order to understand user feedback at scale and aid in brand reputation management.

Language translationprovides wider coverage to organizations across languages and geographies with fluent translations and multilingual capabilities.

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

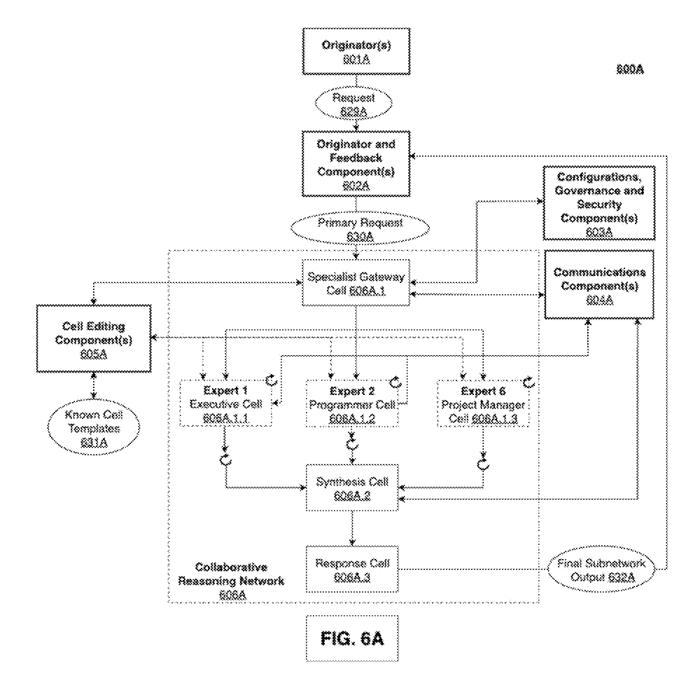

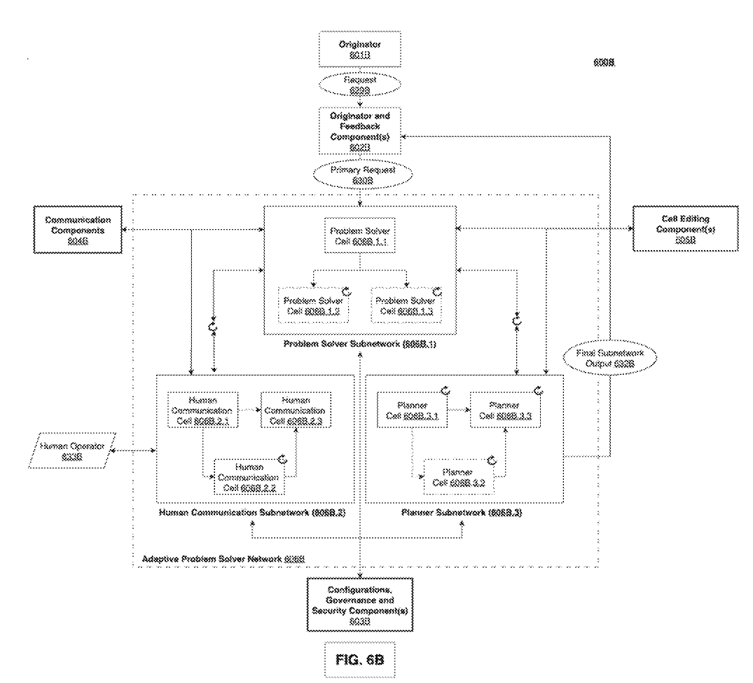

FIG. 6A illustrates an example configuration of a collaborative reasoning network 606A that processes a primary request 630A originating from one or more originators 601A. An originator 601A may issue a request 629A that is received by an originator and feedback component 602A. The originator and feedback component 602A may record the request 629A, generate the primary request 630A, and track feedback from the originator 601A during or after processing.

The primary request 630A may be routed to a specialist gateway cell 606A.1, which determines whether the request requires specialized handling, and if so, distributes sub-tasks to one or more expert cells within the collaborative reasoning network 606A. The collaborative reasoning network 606A may comprise expert cells 606A.1.1, 606A.1.2, and 606A.1.3, representing for example an executive cell 606A.1.1, a programmer cell 606A.1.2, and a project manager cell 606A.1.3. Each expert cell may apply its own configured rules, deterministic functions, and artificial intelligence models to perform its assigned task.

Outputs from the expert cells may be forwarded to a synthesis cell 606A.2. The synthesis cell 606A.2 is configured to aggregate results from multiple expert cells, resolve conflicts, and generate a consolidated result set. The consolidated result may then be delivered to a response cell 606A.3. The response cell 606A.3 may format the synthesized output into a form that can be returned to the originator and feedback component 602A and, ultimately, back to the originator 601A as part of the final subnetwork output 632A.

A configurations, governance, and security component 603A may regulate the processing of requests, enforce security policies, and govern allowable configurations of the collaborative reasoning network 606A. A communications component 604A may transmit results or intermediate responses to external systems, users, or other networks.

The collaborative reasoning network 606A may further interact with a cell editing component 605A, which modifies or configures cells during execution. The cell editing component 605A may rely on known cell templates 631A to generate new cells or alter existing ones. For example, the cell editing component 605A may instantiate a new expert cell based on a template if additional specialized processing is required.

In operation, the originator 601A issues a request 629A that is processed into a primary request 630A by the originator and feedback component 602A. The primary request 630A is directed to the specialist gateway cell 606A.1, which allocates subtasks to expert cells 606A.1.1, 606A.1.2, and 606A.1.3. Outputs from these expert cells are aggregated by the synthesis cell 606A.2 and delivered to the response cell 606A.3, which produces the final subnetwork output 632A. Throughout execution, the cell editing component 605A may modify cell behavior using templates 631A, and the configurations, governance, and security component 603A may enforce policies. The communications component 604A ensures that results are delivered to external systems, while the originator and feedback component 602A allows the originator 601A to monitor progress and provide feedback.

FIG. 6B illustrates an adaptive problem solver network 606B that processes a primary request 630B originating from one or more originators 601B. An originator 601B may issue a request 629B, which is received by an originator and feedback component 602B. The originator and feedback component 602B may transform the request 629B into a primary request 630B and manage feedback and updates with the originator 601B during or after processing.

The primary request 630B may be routed to a problem solver cell 606B.1.1. The problem solver cell 606B.1.1 may decompose the request into sub-problems and allocate them to additional problem solver cells such as 606B.1.2 and 606B.1.3. These problem solver cells collectively form a problem solver subnetwork 606B.1, which may iteratively refine or divide the problem into parts that can be managed by other specialized subnetworks.

The adaptive problem solver network 606B further comprises a human communication subnetwork 606B.2, which includes human communication cells 606B.2.1, 606B.2.2, and 606B.2.3. The human communication subnetwork 606B.2 may interface with a human operator 633B, enabling direct interaction between the adaptive problem solver network 606B and external users. The human communication cells 606B.2.1–606B.2.3 may exchange clarifications, gather additional inputs, or validate outputs before they proceed further in the network.

The adaptive problem solver network 606B also comprises a planner subnetwork 606B.3, which includes planner cells 606B.3.1,606B.3.2, and 606B.3.3. The planner subnetwork 606B.3 may generate task sequences, assign responsibilities, and establish execution order based on the decomposed problem received from the problem solver subnetwork 606B.1. Planner cells may operate cooperatively, with cell 606B.3.2, for example, functioning as a sub-planner to handle specialized tasks, while cells 606B.3.1 and 606B.3.3 manage higher-level orchestration.

Outputs from the problem solver subnetwork 606B.1, the human communication subnetwork 606B.2, and the planner subnetwork 606B.3 are integrated to generate a final subnetwork output 632B. This final subnetwork output 632B is provided back through the originator and feedback component 602B, ensuring that the originator 601B can review, validate, and confirm the result.

The adaptive problem solver network 606B may further interact with a cell editing component 605B. The cell editing component 605B may alter, add, or remove problem solver cells, human communication cells, or planner cells dynamically based on templates or execution requirements. A communications component 604B may deliver information between the adaptive problem solver network 606B and external systems or users. A configurations, governance, and security component 603B may enforce execution policies, validate configurations, and govern security requirements of the network.

In operation, the originator 601B issues a request 629B, which is processed into a primary request 630B by the originator and feedback component 602B. The primary request 630B is directed to the problem solver cell 606B.1.1, which coordinates sub-problem allocation across problem solver cells 606B.1.2 and 606B.1.3 within the problem solver subnetwork 606B.1. The planner subnetwork 606B.3 develops execution strategies using planner cells 606B.3.1–606B.3.3, while the human communication subnetwork 606B.2 enables validation and augmentation through interaction with a human operator 633B. Outputs are consolidated into the final subnetwork output 632B. Throughout execution, the cell editing component 605B may modify network structure, the communications component 604B may deliver information externally, and the configurations, governance, and security component 603B may enforce policies and safeguards.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
receiving a request to perform an artificial intelligence (AI) task;
dynamically configuring a network of AI nodes for processing the AI task, wherein the dynamically configuring comprises connecting an output of an AI node to an input of a different AI node, among the network of AI nodes;
generating an input for the network of AI nodes which includes an identifier of the AI task and input data;
inputting the input to an initial node among the network of AI nodes;
executing the AI task based on the input, available information and the network of AI nodes to generate an output from a last node in the network of nodes; and
transferring the output to a device.

2. The method of claim 1, wherein each AI node comprises input from the originator component or one or more predictive outputs from another AI node(s) among the network of AI nodes and converting it into a format that is executable by an associated AI model, and a post-processing stage which transforms and then transfers the predictive output(s) generated by the AI model to another AI node among the network of AI nod among the network of AI nodes to the originator component as an output to the user.

3. The method of claim 1, further comprising receiving a request from an AI node among the network of AI nodes and reconfiguring at least one of an order among the network of AI nodes and a number of AI nodes included in the network of AI nodes based on the request.

4. The method of claim 1, wherein the dynamically configuring comprises dynamically arranging input / output connections among AI nodes included in the network of AI nodes based on a type of the AI task and sub-tasks to be performed for the type of AI task.

5. The method of claim 1, further comprising:
combining multiple AI Systems configurations in the AI node;
executing each AI System configuration in parallel to generate a set of predictive outputs; and
merging the set of predictive outputs into a consolidated result that is forwarded to the following AI nodes or the last AI node.

6. The method of claim 1, further comprising:
detecting a particular AI node among the network of AI nodes has exceeded an iteration threshold while processing a sub-task;
modifying at least one parameter of the particular AI node; and
executing the AI task with the modified particular AI node to resolve the sub-task.

7. The method of claim 1, wherein dynamically configuring the network of AI nodes comprises:
assigning a designated role to each of a plurality of parallel AI nodes to produce
respective partial solutions; and
combining the respective partial solutions via a combiner AI node.

8. The method of claim 1, wherein executing the AI task comprises storing a predictive output generated by the initial node or any of the intermediate AI nodes in a database using at least one semantic metadata label identifying at least one of the initial node, a task context, or an iteration identifier, wherein retrieving the predictive output using at least one semantic metadata label is performed by the following AI nodes or the last AI node.

9. The method of claim 1, wherein the executing the AI task comprises transforming a predictive output generated by the initial node into a set metadata store representing semantic relationships between elements of the predictive output, wherein querying the metadata from a knowledge graph or database is performed by the following AI Nodes or the last AI node to generate an input for the AI Task or the output to the originator.

10. A system comprising:
at least one processor, wherein the memory and the at least one processor are
communicatively coupled, wherein the at least one processor is configured to:
receive a request to perform an artificial intelligence (AI) task;
dynamically configure a network of AI nodes for processing the AI task,
wherein the dynamically configuration comprises a connection of an output of an AI node to an input of a different AI node, among the network of AI nodes;
generate an input for the network of AI nodes which includes an identifier
of the AI task and input data;
input the input to an initial node among the network of AI nodes;
execute the AI task based on the input, available information and the network of AI nodes to
generate an output from a last node in the network of nodes; and
transfer the output to a device.

11. The system of claim 10, wherein each AI node comprises input from the originator component or one or more predictive outputs from another AI node(s) among the network of AI nodes and converts it into a format that is executable by an associated AI model, and a post-processing stage which transforms and then transfers the predictive output(s) generated by the AI model to another AI node among the network of AI nodes to the originator component as an output to the user.

12. The system of claim 10, wherein the at least one processor is further configured to receive a request from an AI node among the network of AI nodes and reconfigure at least one of an order among the network of AI nodes and a number of AI nodes included in the network of AI nodes based on the request.

13. The system of claim 1, wherein the dynamic configuration comprises dynamic arrangement of input / output connections among AI nodes included in the network of AI nodes based on a type of AI task and sub-tasks to be performed for the type of AI task.

14. The system of claim 10, wherein the at least one processor is further configured to:
combine multiple AI System configurations in the AI node;
execute each AI System configuration in parallel to generate a set of predictive outputs; and
merge the set of predictive outputs into a consolidated result that is forwarded to the last AI node.

15. The system of claim 10, wherein the at least one processor is further configured to:
detect a particular AI node among the network of AI nodes has exceeded an iteration threshold while a sub-task is being processed;
modify at least one parameter of the particular AI node; and
execute the AI task with the modified particular AI node to resolve the sub-task.

16. The system of claim 1, wherein the dynamic configuration comprises:
assign a designated role to each of a plurality of parallel AI nodes to produce
respective partial solutions; and
combine the respective partial solutions via a combiner AI node.

17. The system of claim 1, wherein the execution of the AI task comprises storage of a predictive output generated by the initial node in a database using at least one semantic metadata label that identifies at least one of the initial node, a task context, or an iteration identifier, wherein retrieval of the predictive output using the at least one semantic metadata label is performed by the following AI nodes or the last AI node.

18. The system of claim 1, wherein the execution of the AI task comprises transformation of a predictive output generated by the initial node node or any of the intermediate AI nodes into a metadata store that represent semantic relationships between elements of the predictive output, wherein the metadata store is queried from a knowledge graph or database is performed by the following AI Nodes or the last AI node to generate an input for the AI Task or the output to the originator.

19. A non-transitory computer readable storage medium comprising instructions, that when read by a processor, cause the processor to perform:
receiving a request to perform an artificial intelligence (AI) task;
dynamically configuring a network of AI nodes for processing the AI task, wherein the dynamically configuring comprises connecting an output of an AI node to an input of a different AI node, among the network of AI nodes;
generating an input for the network of AI nodes which includes an identifier of the AI task and input data;
inputting the input to an initial node among the network of AI nodes;
executing the AI task based on the input, available information and the network of AI nodes to generate an output from a last node in the network of nodes; and
transferring the output to a device.

20. The non-transitory computer readable storage medium of claim 19, wherein each AI node comprises input from the originator component or one or more predictive outputs from another AI node(s) among the network of AI nodes and converting it into a format that is executable by an associated AI model, and a post-processing stage which transforms and then transfers the predictive output(s) generated by the AI model to another AI node among the network of AI nodes.
